(19) United States
(12) Patent Application Publication
(10) Pub. No.: US 2015/0254616 A1
(43) Pub. Date: Sep. 10, 2015

(54) SYSTEM AND METHOD FOR MANAGING A DISTRIBUTION NETWORK OF INVESTMENT MONEY

(71) Applicant: SAMSUNG SECURITIES CO., LTD., Seoul (KR)

(72) Inventors: Ki Hoon LEE, Seoul (KR); Jin Heung BAE, Seoul (KR)

(21) Appl. No.: 14/721,853

(22) Filed: May 26, 2015

Related U.S. Application Data
(63) Continuation of application No. 13/820,752, filed on May 6, 2013.

(30) Foreign Application Priority Data
Sep. 6, 2010 (KR) 10-2010-0086860

(51) Int. Cl. G06Q 20/10

(52) U.S. Cl. CPC G06Q 20/10; G06Q 40/06

(57) ABSTRACT

This disclosure relates to a system and method for managing a distribution channel of investment money of a customer, which includes a plurality of modules systematically disposed in a communication pipeline of an IM managing backbone server, so that when an IM rebalancing opportunity situation occurs, a plurality of units, possessed by a customer, is guided to form a set of IM rebalancing distribution channel networks where the units are densely connected each other like a mesh, so that a customer or 1M management company may not simplify but diversify rebalancing paths of IPs or IP portfolio into various patterns and therefore effectively enjoy resultant economic benefits.

### CROSS REFERENCE TO RELATED APPLICATIONS

This application is a continuation of U.S. application Ser. No. 13/820,752 having a filing date of May 6, 2013, which is the National Stage of International Application No. PCT/KR2011/006585, having an International filing date of Sep. 6, 2011, which designated the United States of America, and which International Application was published under PCT Article 21(s) as WO Publication 2012/033325 A1, and which claims priority from and the benefit of Korean Application No. 10-2010-0086860, filed on Sep. 6, 2010, the disclosures of which are incorporated herein by reference in their entireties.

### FIELD OF THE INVENTION

This disclosure relates to a system and method for managing a distribution channel of investment money of a customer.

### BACKGROUND OF THE INVENTION

Recently, along with a rapidly expanding economic size, the number of customers, e.g., personal customers and company customers, managing investment money (IM) is rapidly increasing. Accordingly, the importance of an IM management company, for example, a stock trading company, generally managing the IM of a customer is also greatly increasing.

As shown in FIG. 1, a general computerized system for managing customer IM includes an IM managing backbone server 1 for general computerized investment/management of a customer IM 2 that uses units connected to various investment products (IPs) to invest the customer IM 2 in high risk IPs such as corporate bonds with a low credit rating, stocks, capital unprotected equity linked securities (ELS), stock funds seeking a profit in a market return level, stock funds seeking a profit over a market return level, derivative products, investment funds, credit stock trading, equity linked warrants (ELW), futures/options and the like, or in low risk IPs such as money market funds (MMF), repurchase paper, cash management accounts (CMA), national bonds, local bonds, guaranteed bonds, bank debentures, corporate bonds with a high credit rating, bond funds, capital guarantee ELS and the like.

Under such a general system, a high risk IP or a low risk IP inevitably exhibits frequent volatility of liquidity according to rapid changes in social and economic environments. Therefore, in some cases, it is more advantageous to possess more high risk IPs, and in some cases, it is more advantageous to possess more low risk IPs.

For example, when a stock price or relevant index gets relatively higher or a subsidiary trading index considering market supply and demand suggests selling a given IP or represents an overestimated stock price, e.g., at upside breakout of a Bollinger band, appearance of moving average convergence-divergence (MACD) sell signal, or candle pattern sell signal, possessing more low risk IPs is advantageous over possessing more high risk IPs. In an inverse case, possessing more high risk IPs is advantageous over possessing more low risk IPs.

After thoroughly considering the above, if a stock price or relevant index gets relatively higher or a subsidiary trading index considering market supply and demand suggests selling a given IP or represents an overestimated stock price, e.g., at upside breakout of a Bollinger band, appearance of MACD sell signal, or candle pattern sell signal, the general IM managing backbone server 1 rebalances IM from a unit A to a unit B so that a customer may possess more low risk IPs. Conversely, the general IM managing backbone server 1 rebalances IM from the unit B into the unit A so that a customer may possess more high risk IPs.

If the IM managing backbone server 1 performs such rebalancing measures, even though the financial market exhibits frequent volatility of liquidity or the like, a customer may manage their IM under a more advantageous condition.

However, in the above described system, the IM managing backbone server 1 just fragmentarily takes only a set of bidirectional balancing measures with respect to relative single units of the customer, namely the units A and B. Therefore, despite the management of the IM managing backbone server 1, the rebalancing path of each customer IP is inevitably simplified to a bidirectional relation between the single units A and B. As a result, the portfolio of IPs possessed by the customer inevitably exhibits an extremely simple pattern.

If the rebalancing path or portfolio of the customer IP is simplified as described above, even though the IM managing backbone server 1 takes a rebalancing measure, the corresponding customer may not stably manage their asset value and cannot avoid various tangible/intangible losses accordingly.

Under the circumstance where the above problems are present, if there is no separate countermeasure, each customer cannot help but passively manage the IM 2. As a result, each IM management company cannot avoid a great damage in the overall asset investment market.

### SUMMARY OF THE INVENTION

The present invention is directed to a system and method for managing an investment money (IM) distribution channel. When a given set of IM rebalancing opportunity situations occurs, a plurality of financial product management units possessed by a given customer, i.e., customer-possessing units, is rebalanced according to a preset quantity, amount or importance while forming a set of IM rebalancing distribution channel networks or investment product rebalancing distribution channel network. As used herein, each financial product management unit is a bank account, account, virtual account, unified managed account (UMA) or the like. The financial product management units are densely connected to each other like a mesh according to a set of predetermined serial rebalancing distribution channels or chainlike rebalancing distribution channels, as opposed to automatic simple ordering. Therefore, a customer or IM management company, for example, a stock trading company, may be guided not to simplify but to diversify, rebalancing paths of investment products (IPs) or an IP portfolio into various patterns, effectively achieving a resultant economic benefit.

In accordance with one embodiment, the present invention systematically disposes and associates a computing module capable of checking a change situation, for example, a target figure reaching situation of an IP connected to each customer-possessing unit, a lower limit (or upper limit) touch situation of an IP connected to each customer-possessing unit, a stock price situation of an IP connected to each customer-possessing unit or the like, of an IP connected to a plurality of customer-possessing units or a change situation, for example, various index and indicator situations, news situations, external event occurrence situations or the like, of a financial market to which one or more IPs belong, i.e., an IP-belonged financial market, a computing module capable of comparing the checked change situation of the customer-possessing IP or the checked change situation of the IP-belonged financial market with IM rebalancing distribution channel setting information, previously stored, and of determining whether the corresponding change situation corresponds to an opportunity situation where the IM needs to be rebalanced, a computing module capable of, in a case where the change situation of the customer-possessing IP or the change situation of the IP-belonged financial market corresponds to an opportunity situation where the IM needs to be rebalanced, generating IM rebalancing execution information for the plurality of customer-possessing units according to the IM rebalancing distribution channel setting information and of transmitting the generated IM rebalancing execution information to the IM managing backbone server so that a set of IM rebalancing executing procedures is performed to the plurality of customer-possessing units under complex relationships thereof in a communication pipeline of an IM managing backbone server. Whereby when an IM rebalancing opportunity situation occurs, the plurality of customer-possessing units is guided to be rebalanced according to a preset quantity, amount or importance while forming a set of IM rebalancing distribution channel networks or investment product rebalancing distribution channel network where the units are densely connected to each other like a mesh according to a set of predetermined serial rebalancing distribution channels or chainlike rebalancing distribution channels, instead of automatic simple ordering, so that a customer or IM management company, for example, a stock trading company or the like, may be guided not to simplify but to diversify rebalancing paths of investment products or an IP portfolio into various patterns and therefore effectively achieving a resultant economic benefit.

In one embodiment, there is provided a system for managing a distribution channel of investment money (IM). The system includes an IM distribution channel management control module for communicating with an IM managing backbone server, which performs computerized management for a process of investing investment money (IM) of a customer to investment products (IP), storing IM rebalancing distribution channel setting information associated with rebalancing of the IM, and controlling a managing procedure of the IM, by means of a plurality of customer-possessing units. The system also includes an IP/market change situation checking module controlled by the IM distribution channel management control module to communicate with the IM managing backbone server and check a change situation of an IP connected to the plurality of customer-possessing units or a change situation of an IP-belonged financial market where the IP is belonged. Also in the system is an IM rebalancing opportunity occurrence determining module controlled by the IM distribution channel management control module to communicate with the IP/market change situation checking module, check a change situation of a customer-possessing IP or a change situation of the IP-belonged financial market, then compare the checked change situation of the customer-possessing IP or the checked change situation of the IP-belonged financial market with the IM rebalancing distribution channel setting information, previously stored, and determine whether the corresponding change situation corresponds to an opportunity situation where the IM needs to be rebalanced. An IM rebalancing execution information generating module controlled by the IM distribution channel management control module is provided in the system, wherein in a case where the change situation of the customer-possessing IP or the change situation of the IP-belonged financial market corresponds to an opportunity situation where the IM needs to be rebalanced, the IM rebalancing execution information generating module generates IM rebalancing execution information for the plurality of customer-possessing units according to the IM rebalancing distribution channel setting information. The system also includes an IM rebalancing execution notifying module controlled by the IM distribution channel management control module to transmit the IM rebalancing execution information to the IM managing backbone server so that an IM rebalancing executing procedure is performed to the plurality of customer-possessing units, subject to computerized management of the IM managing backbone server, under complex relationships thereof.

In another general aspect, there is provided a method for managing a distribution channel of IM. This method includes communicating with an IM managing backbone server, which performs computerized management for a process of investing investment money (IM) of a customer to investment products (IP) to check a change situation of a customer-possessing IP connected to the plurality of customer-possessing units or a change situation of an IP-belonged financial market which the IP belongs to, comparing the checked change situation of the customer-possessing IP or the checked change situation of the IP-belonged financial market with IM rebalancing distribution channel setting information, previously stored, associated with rebalancing of the IM and determining whether the corresponding change situation corresponds to an opportunity situation where the IM needs to be rebalanced. The method also includes generating IM rebalancing execution information for the plurality of customer-possessing units according to the IM rebalancing distribution channel setting information in a case where the change situation of the customer-possessing IP or the change situation of the IP-belonged financial market corresponds to an opportunity situation where the IM needs to be rebalanced and transmitting the IM rebalancing execution information to the IM managing backbone server so that an IM rebalancing executing procedure is performed to the plurality of customer-possessing units, subject to computerized management of the IM managing backbone server, under complex relationships thereof.

Since a computing module capable of checking a change situation, for example, a target figure reaching situation of an IP connected to each customer-possessing unit, a lower limit (or upper limit) touch situation of an IP connected to each customer-possessing unit, a stock price situation of an IP connected to each customer-possessing unit or the like, of an IP connected to a plurality of customer-possessing units or a change situation, for example, various index and indicator situations, news situations, external event occurrence situations or the like, of an IP-belonged financial market, a computing module capable of comparing the checked change situation of the customer-possessing IP or the checked change situation of the IP-belonged financial market with IM rebalancing distribution channel setting information, previously stored, and determining whether the corresponding change situation corresponds to an opportunity situation where the IM needs to be rebalanced, a computing module capable of, in a case where the change situation of the customer-possessing IP or the change situation of the IP-belonged financial market corresponds to an opportunity situation where the IM needs to be rebalanced, generating IM rebalancing execution information for the plurality of customer-possessing units according to the IM rebalancing distribution channel setting information and transmitting the generated IM rebalancing execution information to the IM managing backbone server so that a set of IM rebalancing executing procedures is performed to the plurality of customer-possessing units under complex relationships thereof or the like, are systematically disposed and associated in a communication pipeline of an IM managing backbone server of the present disclosure, under a circumstance where the present invention is implemented, when a set of IM rebalancing opportunity situations occur, the plurality of customer-possessing units may be guided to be rebalanced according to a preset quantity, amount or importance while forming a set of IM rebalancing distribution channel networks or investment product rebalancing distribution channel network where the units are densely connected to each other like a mesh according to a set of predetermined serial rebalancing distribution channels or chainlike rebalancing distribution channels, instead of automatic simple ordering, so that a customer or IM management company, for example, a stock trading company or the like, may be guided not to simplify but to diversify rebalancing paths of investment products or IP portfolio into various patterns and therefore effectively achieving a resultant economic benefit.

### BRIEF DESCRIPTION OF THE DRAWINGS

FIG. 1 is a schematic view exemplarily showing a general procedure for rebalancing an IM or IP.

FIG. 2 is a schematic view exemplarily showing a procedure for rebalancing an IM or IP according to the present disclosure.

FIG. 3 is a schematic view exemplarily showing a pattern of IM rebalancing path networks or a pattern of IP rebalancing path networks among a plurality of customer-possessing units according to the present disclosure.

FIG. 4 is a schematic view exemplarily showing a detailed configuration of an IM distribution channel managing system according to the present disclosure.

FIG. 5 is a schematic view exemplarily showing function executing procedures of a guide frame managing module and an IM rebalancing projected path template providing module according to the present disclosure.

FIG. 6 is a schematic view exemplarily showing function executing procedures of an IP/market change situation checking module, an IM rebalancing opportunity occurrence determining module, and an IM rebalancing execution information generating module according to the present disclosure.

FIG. 7 is a schematic view exemplarily showing function executing procedures of an IM rebalancing execution notifying module and an IM rebalancing result notifying module according to the present disclosure.

FIG. 8 is a schematic view exemplarily showing function executing procedures of an IM rebalancing resetting supporting module and an IM rebalancing projected path template providing module according to the present disclosure.

FIG. 9 is a schematic view exemplarily showing a pattern of IM rebalancing path networks (or, a pattern of IP rebalancing path networks) among a plurality of customer-possessing units according to another embodiment of the present disclosure.

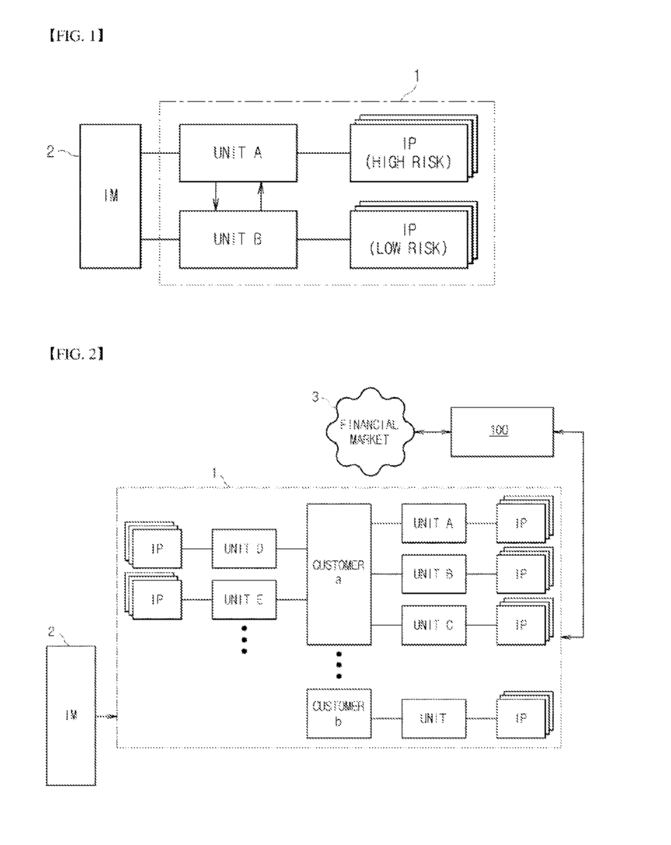

### DETAILED DESCRIPTION

Hereinafter, an IM distribution channel managing system according to the present disclosure will be described in detail with reference to the accompanying drawings.

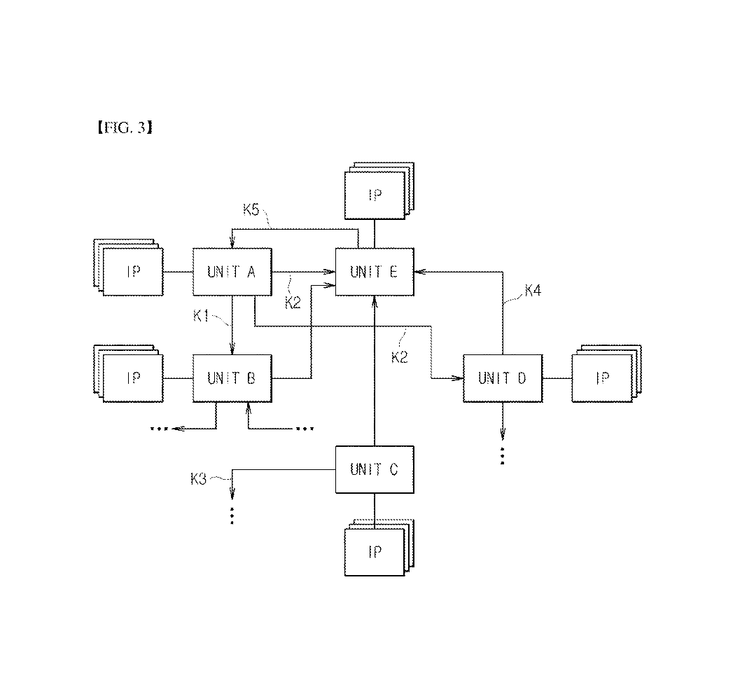

As shown in FIG. 2, an IM managing backbone server 1 for general computerized investment/management of a customer IM 2 uses a plurality of customer-possessing units, for example, unit A, unit B, unit C, unit D, unit E or the like, possessed by a given customer, i.e., customer a. As illustrated, each customer-possessing unit is a unit of IM possessed by a given customer and represents a financial product management unit such as a bank account, account, virtual account, unified managed account (UMA) or the like, connected to various investment products (IPs) to invest the customer's IM 2 in IPs such as corporate bonds with a low credit rating, stocks, capital unprotected equity linked securities (ELS), stock funds seeking a profit in a market return level, stock funds seeking a profit over a market return level, derivative products, investment funds, credit stock trading, equity linked warrants (ELW), futures/options, money market funds (MMF), repurchase paper, cash management accounts (CMA), national bonds, local bonds, guaranteed bonds, bank debentures, corporate bonds with a high credit rating, bond funds, capital guarantee ELS or the like.

The present invention devises additional installation of a specific IM distribution channel managing system 100 in a communication pipeline of the IM managing backbone server 1. In one embodiment, the IM distribution channel managing system 100 forms a structure subordinately installed in a program block of the IM managing backbone server 1.

The IM distribution channel managing system 100 of the present invention checks a change situation, for example, a target figure reaching situation of an IP connected to each customer-possessing unit, a lower limit (or upper limit) touch situation of an IP connected to each customer-possessing unit, a stock price situation of an IP connected to each customer-possessing unit or the like, of an IP connected to a plurality of customer-possessing units, for example, unit A, unit B, unit C, unit D, unit E or the like possessed by a given customer a, or a change situation, for example, various index and indicator situations, news situations, external event occurrence situations or the like, of an IP-belonged financial market, i.e., a financial market to which one of more IPs belong. The system identifies a case where the checked change situation of the customer-possessing IP or the checked change situation of the IP-belonged financial market corresponds to a set of opportunity situations where the IM needs to be rebalanced. These opportunity situations include, a situation where a given IP connected to the unit A reaches a target figure, a situation where a stock price of a given IP belonging to the unit C touches a preset lower limit (or upper limit), a situation where a stock price of a given IP connected to the unit D and a stock price of a given IP connected to the unit E differ from each other by a predetermined percentage, a situation where a given index reaches a prescribed point, and a situation where a news informing that a given oil price rises over a pre-determined dollar level is publicly announced, or the like. Such opportunity situations may change in various ways according to circumstances or a given customer's setting details. The IM distribution channel managing system 100 of the present invention communicates with the IM managing backbone server 1 and supports a set of IM rebalancing executing procedures to be executed under complex relationships with respect to a plurality of customer-possessing units, for example, unit A, unit B, unit C, unit D, unit E or the like possessed by a given customer a.

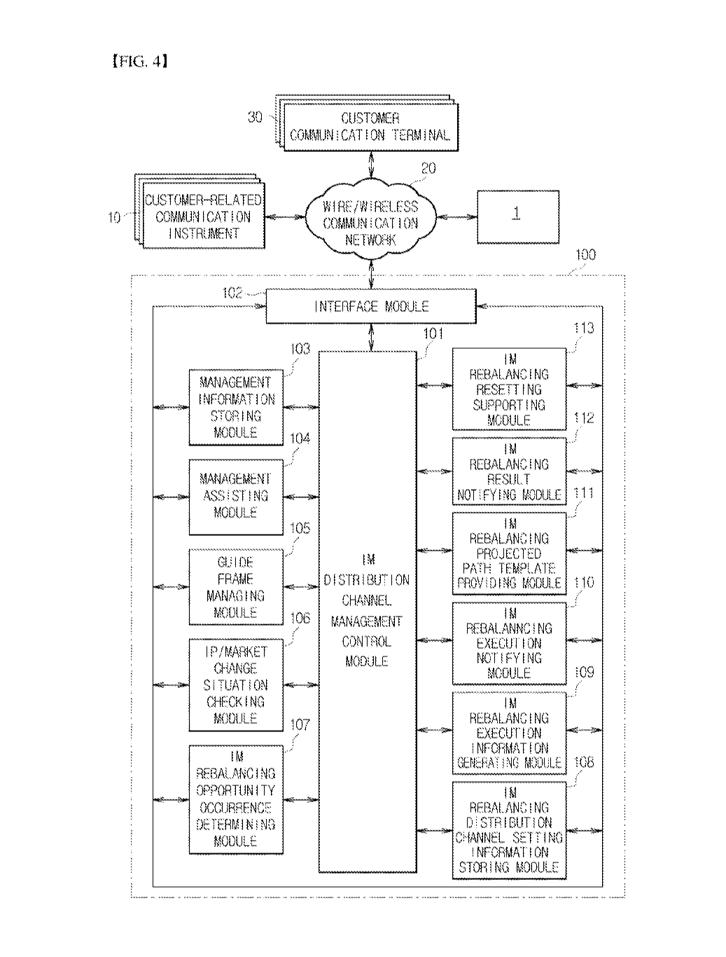

As shown in FIG. 3, a set of IM rebalancing opportunity situations has occurred. These opportunity situations include, a situation where a given IP connected to the unit A reaches a target figure, a situation where a stock price of a given IP belonging to the unit C touches a preset lower limit (or upper limit), a situation where a stock price of a given IP connected to the unit D and a stock price of a given IP connected to the unit E differ from each other by a predetermined percentage, a situation where a given index reaches a prescribed point, and a situation where a news informing that a given oil price rises over a pre-determined dollar level is publicly announced, or the like. The plurality of customer-possessing units, for example, unit A, unit B, unit C, unit D, unit E or the like possessed by a given customer a are guided to be rebalanced according to a preset quantity, amount or importance while forming a set of IM rebalancing distribution channel networks or investment product rebalancing distribution channel networks. These are represented by K1, K2, K3, K4, K5, and the customer-possessed units are densely connected to each other like a mesh according to a set of predetermined serial rebalancing distribution channels or chainlike rebalancing distribution channels, instead of automatic simple ordering. Therefore, the customer or IM management company, for example, a stock trading company, may diversify rebalancing paths of the IP or IP portfolio into various patterns and to achieve a resultant economic benefit.

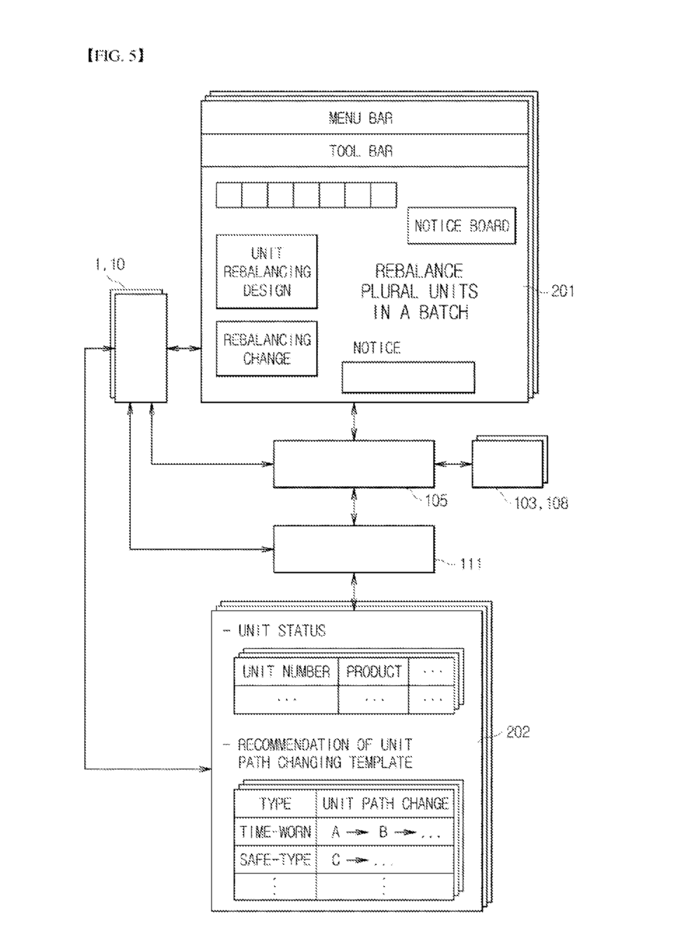

As shown in FIG. 4, the IM distribution channel managing system 100 according to the present invention is in communication with a customer-related communication instrument 10, for example, a communication instrument directly used by a customer or a communication instrument of an IM management company where a customer visits such as a PC, a mobile communication instrument or the like and a customer communication terminal 30, for example, an electronic mail sending/receiving account, a mobile communication instrument, a short message service sending/receiving account, a social network message sending/receiving account or the like, possessed by a customer or managed by a customer. The IM distribution channel managing system 100 includes an IM distribution channel management control module 101 for controlling/assisting the overall IM managing procedure while communicating with the IM managing backbone server 1 as well as a management information storing module 103, a management assisting module 104, a guide frame managing module 105, an IP/market change situation checking module 106, an IM rebalancing opportunity occurrence determining module 107, an IM rebalancing distribution channel setting information storing module 108, an IM rebalancing execution information generating module 109, an IM rebalancing execution notifying module 110, an IM rebalancing projected path template providing module 111, an IM rebalancing result notifying module 112, and an IM rebalancing resetting supporting module 113. These modules are controlled by the IM distribution channel management control module 101 and are closely associated through a wired or wireless communication network 20, for example, a wired or wireless Internet network, a wired or wireless financial communication network or the like, and an interface module 102.

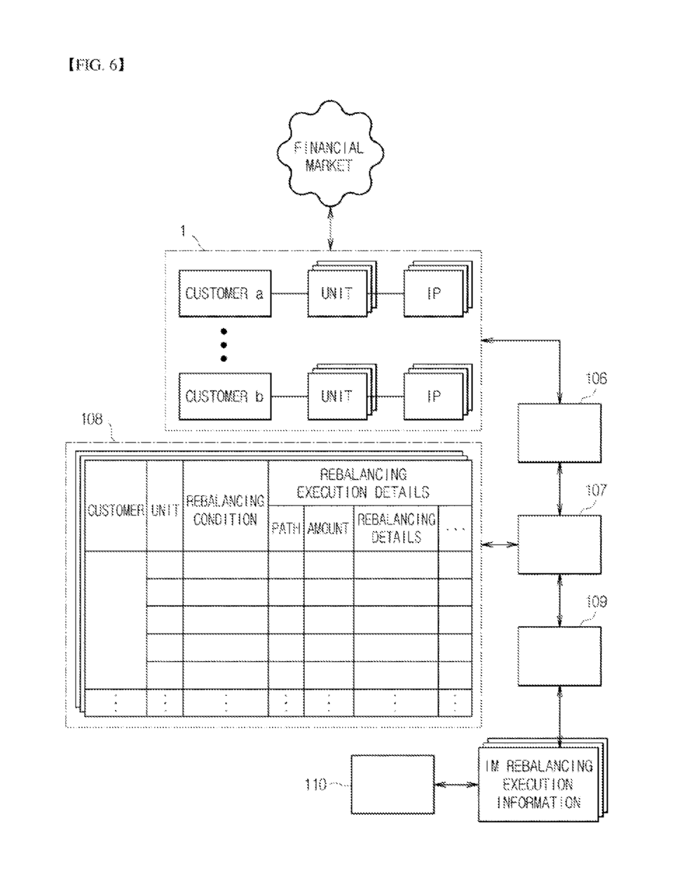

Here, the management information storing module 103 stably stores and manages various kinds of management information required for the IM distribution channel managing service, for example registration information of the customer, registration information of the IM managing backbone server 1, resource status information of the system 100, component information required for executing a computing process of each computing module in the system 100, text information/graphic information/setting information for generating a guide frame 201 (see FIG. 5) or the like, in its information storage area. The item or range of each information listed above may be elastically added, deleted or changed according to the circumstance of the system 100.

In addition, the management assisting module 104 performs various auxiliary management procedures required for the IM distribution channel management service, for example a procedure of managing a system logging-in process of a customer, a procedure of establishing/maintaining a communication session with exterior computing devices 1, 10, 30, and a procedure of updating/managing the management information or the like, in various ways.

Moreover, the IM rebalancing distribution channel setting information storing module 108 plays a role of storing and managing various setting information associated with IM rebalancing, namely, rebalancing condition information and rebalancing target/quantity/amount/importance execution details information or the like of each unit set by the customer. This setting information includes in the case of a given IP connected to the unit A reaching a target figure, selling the given IP of the unit A and buying the given IP of the unit B, and additionally buying the given IP of the unit D. Another setting information is in the case where the stock price of a given IP belonging to the unit C touches a preset lower limit (or, upper limit), selling the given IP of the unit C and buying the given IP of the unit B, and additionally buying the given IP of the unit D. Another setting information is in case a stock price of a given IP connected to the unit D and a stock price of the given IP connected to the unit E are different from each other by a predetermined percentage, selling the given IP of the unit D and buying the given IP of the unit A, and additionally buying the given IP of the unit C. One setting information states that in the case where a given index reaches a given point, selling a given IP of the unit A and buying the given IP of the unit C, and additionally buying the given IP of the unit D. In one embodiment, the setting information provides in the case where news informing that a given oil price rises over a prescribed dollar amount is publicly announced, selling the given IP of the unit C and buying the given IP of the unit A, and additionally buying the given IP of the unit D. (see FIG. 6).

Referring to FIG. 5, in a case where a customer logs into the system 100 through the customer-related communication instrument 10, the guide frame managing module 105 controlled by the IM distribution channel management control module 101 communicates with the management information storing module 103, extracts text information/graphic information/setting information or the like for generating a guide frame 201, generates a guide frame 201 by utilizing the extracted text information/graphic information/setting information or the like, transmits the generated guide frame 201 to the IM managing backbone server 1, and provides support so that the corresponding guide frame 201 may be output and notified via the wire/wireless communication network 20 through the customer-related communication instrument 10 which is in access to the IM managing backbone server 1. The output path of the guide frame may be modified in various ways according to the circumstances.

In the state where the guide frame 201 is output and notified, the customer may freely set various kinds of setting information, i.e., rebalancing conditions and execution detail information of each customer-possessing unit, associated with rebalancing of the IM by just a simple computing procedure of selecting one of various menus displayed at the corresponding guide frame 201.

At this time, the IM rebalancing projected path template providing module 111 controlled by the IM distribution channel management control module 101 communicates with the customer-related communication instrument 10 through the IM managing backbone server 1. In the case where various kinds of setting information associated with rebalancing of the IM are being set by the customer, the IM rebalancing projected path template providing module 111 plays the role of generating an IM rebalancing projected path template 202 where a rebalancing projected path of the IM is displayed as a connection relation of the plurality of customer-possessing units. These customer-possessing units include, for example, the unit A, the unit B, the unit C, the unit D, and the unit E. The IM rebalancing projected path template providing module 111 also provides the generated IM rebalancing projected path template 202 to the IM managing backbone server 1.

When the IM rebalancing projected path template providing module 111 performs the above function, a customer accessing the IM managing backbone server 1 through the customer-related communication instrument 10 may effectively refer to the corresponding IM rebalancing projected path template 202 when setting the IM rebalancing distribution channel setting information. As a result, without any difficulty, the user may easily set an IM rebalancing path suitable for the customer's type, for example, a time-worn IM rebalancing path, a safe-type IM rebalancing path, an attacking-type IM rebalancing path or the like.

When the aforementioned infrastructure is prepared, as shown in FIG. 6, the IP/market change situation checking module 106 controlled by the IM distribution channel management control module 101 communicates with the IM managing backbone server 1 through the interface module 102, checks a change situation, for example, a target figure reaching situation of an IP connected to each unit, a lower limit (or upper limit) touch situation of an IP connected to each unit, a stock price situation of an IP connected to each unit or the like, of an IP connected to a plurality of customer-possessing units, for example, the unit A, the unit B, the unit C, the unit D, the unit E or the like possessed by the customer a, or a change situation, for example, various index and indicator situations, news situations, external event occurrence situations or the like, of an IP-belonged financial market, and obtains the corresponding checking result, thereby establishing a basic environment where the IM distribution channel managing procedure according to the present disclosure may be performed normally.

By doing so, a circumstance where the change situation, for example, a target figure reaching situation of an IP connected to each customer-processing unit, a lower limit (or upper limit) touch situation of an IP connected to each customer-processing unit, a stock price situation of an IP connected to each customer-processing unit or the like, of an IP connected to a plurality of customer-possessing units, for example, the unit A, the unit B, the unit C, the unit D, the unit E or the like possessed by the customer a, or the change situation, for example, various index and indicator situations, news situations, external event occurrence situations or the like, of an IP-belonged financial market is checked and inspected. As shown in FIG. 6, the IM rebalancing opportunity occurrence determining module 107 controlled by the IM distribution channel management control module 101 firstly communicates with the IP/market change situation checking module 106 and performs a procedure for figuring out the change situation of the customer-possessing IP or the change situation of the IP-belonged financial market.

Through this procedure, the change situation, for example, a target figure reaching situation of an IP connected to each customer-possessing unit, a lower limit (or upper limit) touch situation of an IP connected to each customer-possessing unit, a stock price situation of an IP connected to each customer-possessing unit or the like, of an IP connected to a plurality of customer-possessing units, for example, the unit A, the unit B, the unit C, the unit D, the unit E or the like possessed by the customer a, or the change situation, for example, various index and indicator situations, news situations, external event occurrence situations or the like, of an IP-belonged financial market is completely figured out. The IM rebalancing opportunity occurrence determining module 107 communicates with the IM rebalancing distribution channel setting information storing module 108 and compares the checked change situation of the customer-possessing IP and the checked change situation of the IP-belonged financial market with IM rebalancing distribution channel setting information, which was previously stored. Therefore, the IM rebalancing opportunity occurrence determining module 107 determines whether the corresponding change situation corresponds to opportunity situations where the IM needs to be rebalanced. These opportunity situations include a situation where a given IP connected to the unit A reaches a target figure, a situation where a stock price of a given IP belonging to the unit C touches a preset lower limit (or upper limit), a situation where a stock price of a given IP connected to the unit D and a stock price of a given IP connected to the unit E are different from each other by a predetermined percentage, a situation where a given index reaches a given point, a situation where a news informing that a certain oil price rises over a prescribed dollar level is publicly announced, or the like. (see FIG. 6).

At this time, if it is determined that the change situation, for example, a target figure reaching situation of an IP connected to each customer-possessing unit, a lower limit (or upper limit) touch situation of an IP connected to each customer-possessing unit, a stock price situation of an IP connected to each customer-possessing unit or the like, of an IP connected to a plurality of customer-possessing units, for example, the unit A, the unit B, the unit C, the unit D, the unit E or the like possessed by the customer a, or the change situation, for example, various index and indicator situations, news situations, external event occurrence situations or the like, of an IP-belonged financial market corresponds to opportunity situations where the IM needs to be rebalanced, for example, a given IP connected to the unit A reaches a target figure, a situation where a stock price of a given IP belonging to the unit C touches a preset lower limit (or upper limit), a situation where a stock price of a given IP connected to the unit D and a stock price of a given IP connected to the unit E are different from each other by a predetermined percentage, a situation where a given index reaches a given point, a situation where a news informing that a certain oil price rises over a prescribed dollar level is publicly announced, or the like, the IM rebalancing opportunity occurrence determining module 107 instantly carries on a data generating routine to generate a message. This message can be to generate IM rebalancing execution information since a situation where the IM needs to be rebalanced occurs. Then the IM rebalancing opportunity occurrence determining module 107 transmits the generated message to the IM rebalancing execution information generating module 109. A plurality of IM rebalancing opportunity situations may occur simultaneously depending on the circumstances.

By doing so, if a message about a situation where the IM needs to be balanced is transmitted, as shown in FIG. 6, the IM rebalancing execution information generating module 109 controlled by the IM distribution channel management control module 101 communicates with the IM rebalancing distribution channel setting information storing module 108 and reads the IM rebalancing distribution channel setting information stored therein. This setting information includes in a case where a given IP connected to the unit A reaches a target figure, selling the given IP of the unit A and buying the given IP of the unit B, and additionally buying the given IP of the unit D, or in a case where the stock price of the given IP belonging to the unit C touches a preset lower limit (or, upper limit), selling the given IP of the unit C and buying the given IP of the unit B, and additionally buying the given IP of the unit D, in a case where a stock price of the given IP connected to the unit D and a stock price of the given IP connected to the unit E are different from each other by a predetermined percentage, selling the given IP of the unit D and buying the given IP of the unit A, and additionally buying the given IP of the unit C, in a case where the given index reaches a prescribed point, selling the given IP of the unit A and buying the given IP of the unit C, and additionally buying the given IP of the unit D, in a case where a news informing that a certain oil price rises over a prescribed dollar level is publicly announced, selling the given IP of the unit C and buying the given IP of the unit A, and additionally buying the given IP of the unit D, or the like. The IM rebalancing execution information generating module 109 then carries out a set of data generating routines according to the read contents, thereby generating a set of IM rebalancing execution information with respect to the plurality of customer-possessing units, for example, the unit A, the unit B, the unit C, the unit D, the unit E or the like possessed by the customer a.

At this time, in a case where the opportunity situation where the IM needs to be rebalanced as mentioned above corresponds to a situation where a given IP connected to the unit A reaches a target figure, the IM rebalancing execution information contains execution details such as sell the given IP of the unit A and buy the given IP of the unit B, and additionally buy the given IP of the unit D, according to the IM rebalancing distribution channel setting information.

In addition, in a case where the opportunity situation where the IM needs to be rebalanced corresponds to, for example, the stock price of the given IP belonging to the unit C touches a preset lower limit (or, upper limit), the IM rebalancing execution information contains execution details such as sell the given IP of the unit C and buy the given IP of the unit B, and additionally buy the given IP of the unit D, according to the IM rebalancing distribution channel setting information.

Moreover, in a case where the opportunity situation where the IM needs to be rebalanced corresponds to, for example, a stock price of the given IP connected to the unit D and a stock price of the given IP connected to the unit E are different from each other by a predetermined percentage, the IM rebalancing execution information contains execution details such as sell the given IP of the unit D and buy the given IP of the unit A, and additionally buy the given IP of the unit C, according to the IM rebalancing distribution channel setting information.

In addition, in a case where the opportunity situation where the IM needs to be rebalanced corresponds to, for example, the given index reaches a prescribed point, the IM rebalancing execution information contains execution details such as sell the given IP of the unit A and buy the given IP of the unit C, and additionally buy the given IP of the unit D, according to the IM rebalancing distribution channel setting information.

Further, in a case where the opportunity situation where the IM needs to be rebalanced corresponds to, for example, a news informing that a certain oil price rises over a prescribed dollar level is publicly announced, the IM rebalancing execution information contains execution details such as sell the given IP of the unit C and buy the given IP of the unit A, and additionally buy the given IP of the unit D, according to the IM rebalancing distribution channel setting information.

By doing so, if a set of IM rebalancing execution information with respect to the plurality of customer-possessing units, for example, the unit A, the unit B, the unit C, the unit D, the unit E or the like possessed by the customer a, is generated, the IM rebalancing execution information generating module 109 transmits the generated IM rebalancing execution information to the IM rebalancing notifying module 110, so that a set of IM rebalancing execution details may be actually performed by the IM managing backbone server 1 (see FIG. 6).

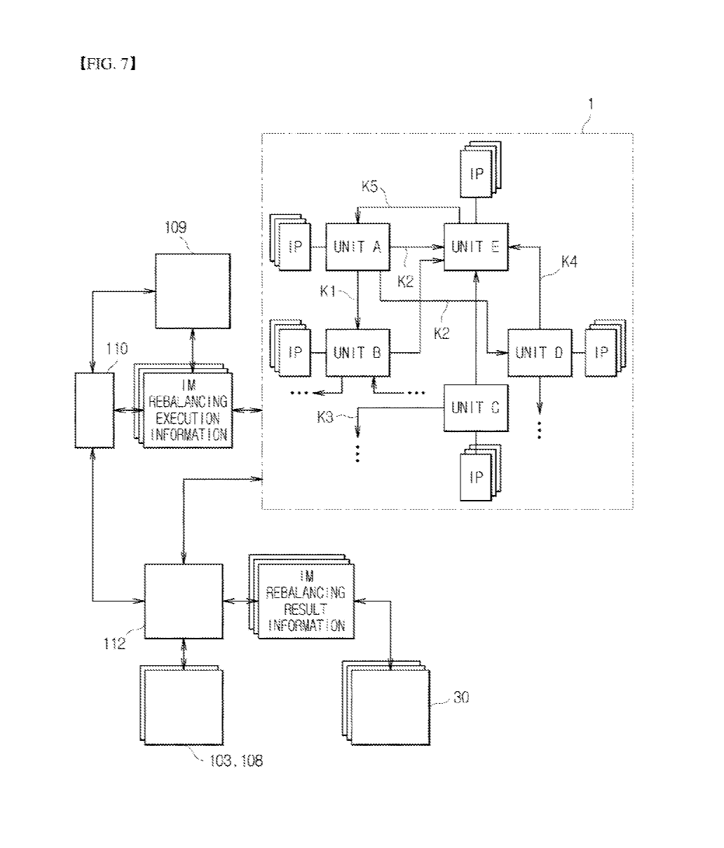

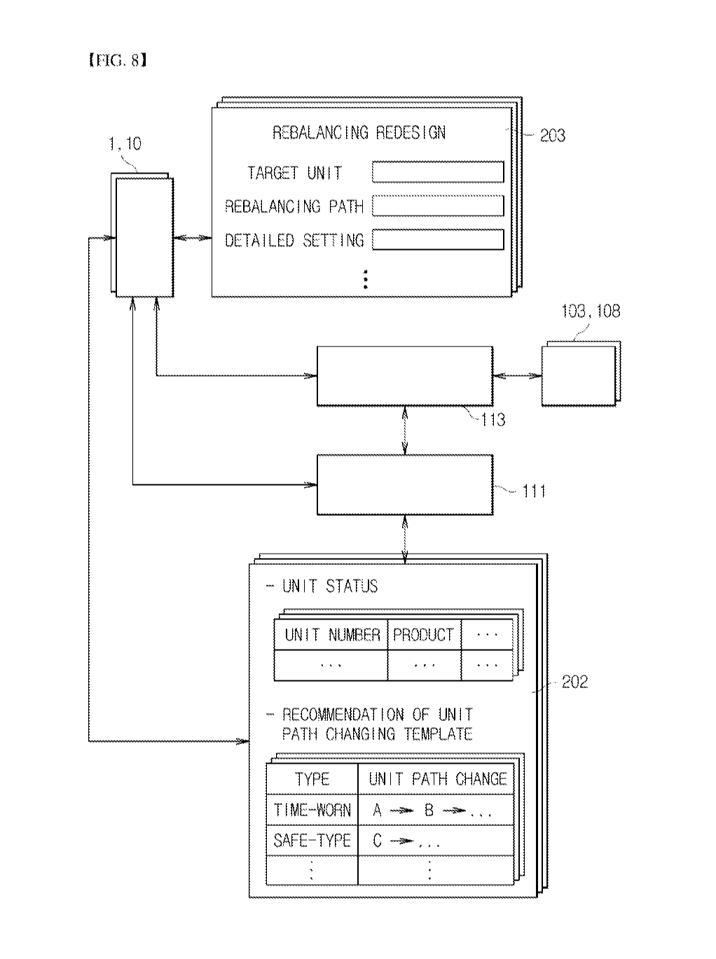

Through the above procedure, if a set of IM rebalancing execution information with respect to the plurality of customer-possessing units, for example, the unit A, the unit B, the unit C, the unit D, the unit E or the like possessed by the customer a, is transmitted, as shown in FIG. 7, the IM rebalancing execution notifying module 110 controlled by the IM distribution channel management control module 101 communicates with the IM rebalancing execution information generating module 109 to receive the information. The IM rebalancing execution notifying module 110 then communicates with the IM managing backbone server 1 through the interface module 102 to transmit the received IM rebalancing execution information to the IM managing backbone server 1. As a result, the plurality of customer-possessing units, for example, the unit A, the unit B, the unit C, the unit D, the unit E or the like possessed by the customer a, computer-managed by the IM managing backbone server 1 may effectively experience a set of IM rebalancing executing procedures under complex relationships thereof.

As described above, a computing module capable of checking a change situation, for example, a target figure reaching situation of an IP connected to each customer-possessing unit, a lower limit (or upper limit) touch situation of an IP connected to each customer-possessing unit, a stock price situation of an IP connected to each customer-possessing unit or the like, of an IP connected to a plurality of customer-possessing units, for example, the unit A, the unit B, the unit C, the unit D, the unit E or the like possessed by the customer a, or the change situation, for example, various index and indicator situations, news situations, external event occurrence situations or the like, of an IP-belonged financial market, a computing module capable of comparing the checked change situation of the customer-possessing IP or the checked change situation of the IP-belonged financial market with IM rebalancing distribution channel setting information, previously stored, and determining whether the corresponding change situation corresponds to an opportunity situation where the IM needs to be rebalanced, a computing module capable of, in case the change situation of the customer-possessing IP or the change situation of the IP-belonged financial market corresponds to an opportunity situation where the IM needs to be rebalanced, generating IM rebalancing execution information for the plurality of customer-possessing units according to the IM rebalancing distribution channel setting information and transmitting the generated IM rebalancing execution information to the IM managing backbone server so that a set of IM rebalancing executing procedures is performed to the plurality of customer-possessing units under complex relationships thereof or the like are systematically disposed in the present invention. Under a circumstance where the present invention is implemented, if a set of IM rebalancing opportunity situations occurs, the plurality of customer-possessing units are guided to be rebalanced according to a preset quantity, amount or importance while forming a set of IM rebalancing distribution channel networks or investment product rebalancing distribution channel networks. These include K1, K2, K3, K4, K5 and the like. This occurs where the units are densely connected to each other like a mesh according to a set of preset serial rebalancing distribution channels or chainlike rebalancing distribution channels, instead of automatic simple ordering, so that the customer or IM management company, for example, a stock trading company or the like, may diversify rebalancing paths of the IP or IP portfolio into various patterns and therefore effectively enjoy resultant economic benefits.

Meanwhile, as described above, under the system of the present invention, a plurality of IM rebalancing opportunity situations of the customer-possessed units may occur together, for example, simultaneously or within a predetermined unit time. In one embodiment, IM rebalancing opportunity situations simultaneously occur at the unit A, the unit C, and the unit E, among others.

In such a sensitive circumstance, the IM rebalancing execution information generating module 109 of the present invention communicates with the IM rebalancing distribution channel setting information storing module 108 and refers to the IM rebalancing distribution channel setting information, which was previously stored. The IM rebalancing execution information generating module 109 then generates priority-processing IM rebalancing execution information according to rebalancing priority processing setting details defined therein, For example, in a case where IM rebalancing opportunity situations simultaneously occur in the unit A, the unit C, and the unit E, rebalancing associated with the unit C is processed first, and then rebalancing associated with the unit E is processed. The IM rebalancing execution information generating module 109 transmits the generated priority-processing IM rebalancing execution information to the IM rebalancing execution notifying module 110.

In this circumstance, the unit A, the unit C, and the unit E may normally experience IM rebalancing procedures in order without any difficulty even though a set of IM rebalancing opportunity situations occurs simultaneously.

As another example, in a case where IM rebalancing opportunity situations occur simultaneously in the unit A, the unit C, and the unit E, possessed by the customer, the IM rebalancing execution information generating module 109 of the present disclosure communicates with the IM rebalancing distribution channel setting information storing module 108 and refers to IM rebalancing distribution channel setting information stored therein. The IM rebalancing execution information generating module 109 then generates a set of netting-processing IM rebalancing execution information according to rebalancing netting-processing setting details defined therein. Examples of rebalancing netting-processing setting details include in a case where IM rebalancing opportunity situations simultaneously occur in the unit A, the unit C, and the unit E, selling/buying orders under setoff relationship among selling/buying orders associated with the unit A, the unit C, and the unit E are set off with each other for 1 day and then set, and they are rebalanced at once according to the net transaction details. The IM rebalancing execution information generating module 109 transmits the generated netting-processing IM rebalancing execution information to the IM rebalancing execution notifying module 110.

In this circumstance, the unit A, the unit C, and the unit E may normally experience netting-type IM rebalancing procedures in order without any difficulty even though a set of IM rebalancing opportunity situations occurs simultaneously.

Meanwhile, as shown in FIG. 4, an IM rebalancing result notifying module 112, an IM rebalancing resetting supporting module 113 or the like is additionally disposed under the control of the IM distribution channel management control module 101, in addition to various computing modules described above.

At this time, as shown in FIG. 7, the IM rebalancing result notifying module 112 controlled by the IM distribution channel management control module 101 communicates with the IM managing backbone server 1 through the interface module 102. If the IM rebalancing executing procedure described above is completed, the IM rebalancing result notifying module 112 instantly carries on a set of data generating routines to generate IM rebalancing execution result information where the corresponding IM rebalancing executing procedure is reflected, and transmits the generated IM rebalancing execution result information to the customer communication terminal 30 managed by the customer. The generated IM rebalancing execution result information is communicated using, for example, an electronic mail sending/receiving account, a mobile communication instrument, a short message service sending/receiving account, a social network message sending/receiving account or the like. In this case, the IM execution result information may be transmitted to the customer communication terminal 30 via the IM managing backbone server 1.

If the IM rebalancing result notifying module 112 functions as described above, the customer may check the rebalancing situation of their IM in real time and therefore effectively enjoy various resultant benefits.

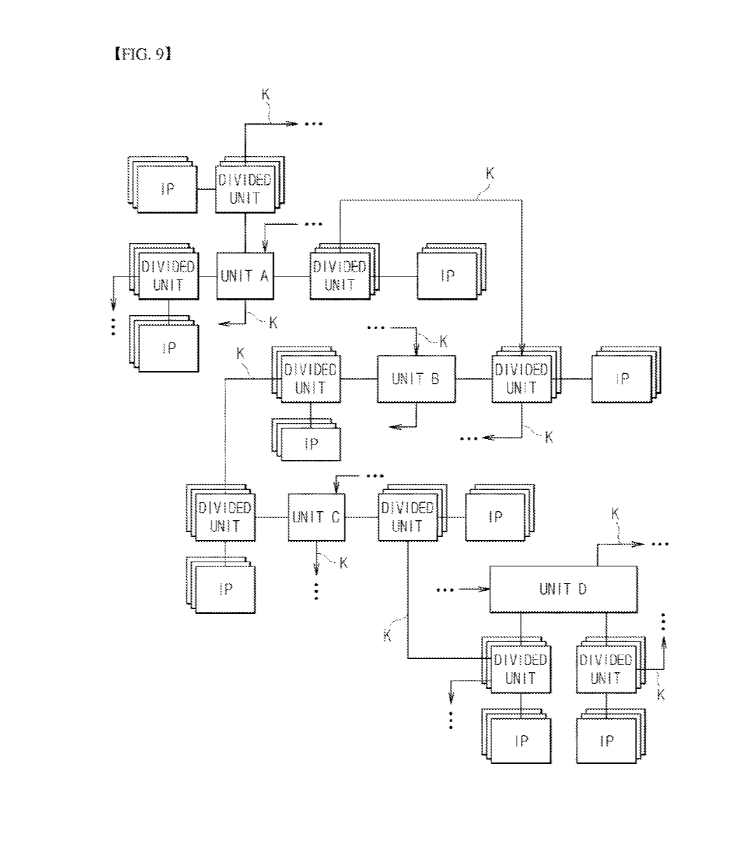

In addition, as shown in FIG. 8, the IM rebalancing resetting supporting module 113 controlled by the IM distribution channel management control module 101 communicates with the customer-related communication instrument 10 through the IM managing backbone server 1, and at the request of a customer, generates a guide frame 203 associated with additional rebalancing setting of the IM. The IM rebalancing resetting supporting module 113 transmits the generated guide frame 203 to the IM managing backbone server 1, so that the customer accessing the IM managing backbone server 1 through the customer-related communication instrument 10 may freely add or change preset IM rebalancing distribution channel setting information as desired.

In this circumstance, the IM rebalancing projected path template providing module 111 controlled by the IM distribution channel management control module 101 communicates with the IM managing backbone server 1. If various kinds of setting information associated with IM rebalancing are being reset by the customer, the IM rebalancing projected path template providing module 111 generates the IM rebalancing projected path template 202 where a rebalancing projected path of the IM is displayed as a connection relation of the plurality of customer-possessing units, for example, the unit A, the unit B, the unit C, the unit D, the unit E or the like possessed by the customer a, and provides the generated IM rebalancing projected path template 202 to the IM managing backbone server 1.

If the IM rebalancing projected path template providing module 111 functions as above, the customer accessing the IM managing backbone server 1 through the customer-related communication instrument 10 may effectively refer to the corresponding IM rebalancing projected path template 202 when resetting the IM rebalancing distribution channel setting information, and easily set an IM rebalancing path suitable for the customer's type without any difficulty. These IM rebalancing paths include, for example, a time-worn IM rebalancing path, a safe-type IM rebalancing path, an attacking-type IM rebalancing path or the like.

The present invention may be modified in various ways according to various embodiments.

For example, in the present invention, as shown in FIG. 9, a plurality of divided units, for example, a divided unit dedicated to a short-term withdrawal schedule, a divided account dedicated to a middle-term withdrawal schedule, a divided unit dedicated to a long-term withdrawal schedule, or the like, for managing deposit or withdrawal of the IM in a state of being connected to a part or all of the plurality of customer-possessing units, for example, the unit A, the unit B, the unit C, the unit D, the unit E or the like possessed by the customer a, may be additionally established.

Under a circumstance where such a divided unit is additionally established, in case a set of IM rebalancing executing procedures is carried on, a plurality of parent units, for example, the unit A, the unit B, the unit C, the unit D, the unit E or the like, and the divided units may form a set of IM rebalancing distribution channel networks or IP rebalancing distribution channel network, K. The units are densely connected like a mesh between them, for example, between the parent unit and the parent unit, between the parent unit and the divided unit, between the divided unit and the divided unit or the like. As a result, the customer or IM management company, for example, a stock trading company or the like, may diversify rebalancing paths of the IP or IP portfolio into various patterns and therefore effectively enjoy resultant economic benefits.

The present disclosure is not limited to a specific field and generally gives useful effects in various fields where investment money or investment products should be managed.

In addition, even though a specific embodiment of the present disclosure has been described and illustrated, it is obvious that the present disclosure can be modified in various ways by those skilled in the art.

Such modifications should not be understood separate from the technical spirit or viewpoint of the present disclosure but be regarded as being included in the scope of the appended claims.

According to the system and method for managing a distribution channel of investment money as described above, when a set of IM rebalancing opportunity situations occurs, a plurality of customer-possessing units may be guided to be rebalanced according to a preset quantity, amount or importance while forming a set of IM rebalancing distribution channel networks where the units are densely connected like a mesh according to a set of preset serial rebalancing distribution channels or chainlike rebalancing distribution channels, instead of automatic simple ordering. As a result, a customer or IM management company may diversify rebalancing paths of an IP or IP portfolio into various patterns and therefore effectively enjoy resultant economic benefits.

What is claimed is:

1. An investment money distribution system comprising:
an investment money backbone server including
a plurality of investment products, and
a plurality of customer possessing units, each customer possessing unit is associated with a given customer and includes a unit of investment money associated with that given customer and being disposed in one of the plurality of investment products;
a distribution channel management control module that is in communication with backbone server and defines distribution channels between the plurality of customer possessing units and the plurality of investment products, where each distribution channel corresponds to an investment product;
a redistribution channel network effected by the distribution channel management control module, the redistribution channel network
defines a manifold network of redistribution channels that provides an interconnection between the plurality of investment products for each customer, where each redistribution channel is associated with a corresponding one of different investment products, and
sets rules to rebalance the redistribution channels on a per customer basis for one or more customers where the rebalanced redistribution channels redistribute a flow of investment money among one or more of the plurality of customer possessing units for a respective customer; and
a rebalancing opportunity module in communication with the redistribution channel network, the rebalancing opportunity module being configured to compare a change situation of the investment products associated with the redistribution channels with the rules to rebalance for determining the occurrence of a redistribution channel rebalancing opportunity for each redistribution channel of the manifold network, where the occurrence of the redistribution channel rebalancing opportunity effects a rebalancing of one or more redistribution channels on the per customer basis based on the rules to rebalance to form at least one rebalanced investment product for one or more respective customers.

2. The investment money distribution system of claim 1, wherein the investment money backbone server further includes a plurality of divided customer possessing units connected to corresponding customer possessing units to manage deposit or withdrawal of investment money.

3. The investment money distribution system of claim 1, wherein the distribution channel management control module is configured to:
generate rebalancing information corresponding to the at least one rebalanced investment product for one or more respective customers, and
transmit the rebalancing information to a customer communication terminal managed by the respective customer to effect a real time customer review of corresponding rebalanced investment products.

4. The investment money distribution system of claim 1, wherein the distribution channel management control module is configured to generate a guide frame that includes a plurality of menus that are graphically presented on a customer communication terminal in communication with the investment money backbone server to facilitate customer setting of respective predetermined rebalancing criteria.

5. The investment money distribution system of claim 4, wherein the distribution channel management control module is further configured to generate, based on the respective predetermined rebalancing criteria, an investment money rebalancing path template for presentation on the customer communication terminal, where the investment money rebalancing path template is graphically presented on the customer communication terminal as a connection relation of the customer possessing units for the respective customer.

6. The investment money distribution system of claim 1, wherein the rules to rebalance include priority processing investment money rebalancing execution information, the priority processing investment money rebalancing execution information being established by a customer setting of respective predetermined rebalancing criteria where the respective customer possessing units for the respective customer are rebalanced by the redistribution channels and the priority processing investment money rebalancing execution information when a plurality of redistribution channel rebalancing opportunities is determined to occur substantially simultaneously or during a predetermined time unit.

7. The investment money distribution system of claim 1, wherein the manifold network of redistribution channels are connected to each other in a mesh according to the rules for rebalancing or are connected to each other in a chainlike configuration.

8. A method for distributing investment money comprising:
providing an investment money backbone server that includes
a plurality of investment products, and
a plurality of customer possessing units, each customer possessing unit is associated with a given customer and includes a unit of investment money associated with that given customer and being disposed in one of the plurality of investment products;
defining, with a distribution channel management control module that is in communication with backbone server, distribution channels between the plurality of customer possessing units and the plurality of investment products, where each distribution channel corresponds to an investment product;
defining, with a redistribution channel network effected by the distribution channel management control module, a manifold network of redistribution channels that provides an interconnection between the plurality of investment products for each customer, where each redistribution channel is associated with a corresponding one of different investment products;
setting rules, with the redistribution channel network, to rebalance the redistribution channels on a per customer basis for one or more customers where the rebalanced redistribution channels redistribute a flow of investment money among one or more of the plurality of customer possessing units for a respective customer; and
comparing, with a rebalancing opportunity module in communication with the redistribution channel network, a change situation of the investment products associated with the redistribution channels with the rules to rebalance for determining the occurrence of a redistribution channel rebalancing opportunity for each redistribution channel of the manifold network, where the occurrence of the redistribution channel rebalancing opportunity effects a rebalancing of one or more redistribution channels on the per customer basis based on the rules to rebalance to form at least one rebalanced investment product for one or more respective customers.

9. The method of claim 8, further comprising managing deposit or withdrawal of investment money with a plurality of divided customer possessing units connected to corresponding customer possessing units stored in the investment money backbone server.

10. The method of claim 8, further comprising:
generating, with the distribution channel management control module, rebalancing information corresponding to the at least one rebalanced investment product for one or more respective customers, and
transmitting, with the distribution channel management control module, the rebalancing information to a customer communication terminal managed by the respective customer to effect a real time customer review of corresponding rebalanced investment products.

11. The method of claim 8, further comprising generating, with the distribution channel management control module, a guide frame that includes a plurality of menus that are graphically presented on a customer communication terminal in communication with the investment money backbone server to facilitate customer setting of respective predetermined rebalancing criteria.

12. The method of claim 11, further comprising generating, with the distribution channel management control module, based on the respective predetermined rebalancing criteria, an investment money rebalancing path template for presentation on the customer communication terminal, where the investment money rebalancing path template is graphically presented on the customer communication terminal as a connection relation of the customer possessing units for the respective customer.

13. The method of claim 8, wherein the rules to rebalance include priority processing investment money rebalancing execution information, the priority processing investment money rebalancing execution information being established by a customer setting of respective predetermined rebalancing criteria where the respective customer possessing units for the respective customer are rebalanced by the redistribution channels and the priority processing investment money rebalancing execution information when a plurality of redistribution channel rebalancing opportunities is determined to occur substantially simultaneously or during a predetermined time unit.

14. The method of claim 8, wherein the manifold network of redistribution channels are connected to each other in a mesh according to the rules for rebalancing or are connected to each other in a chainlike configuration.
